(19) United States
(12) Patent Application Publication
(10) Pub. No.: US 2014/0331160 A1
(43) Pub. Date: Nov. 6, 2014

(54) APPARATUS AND METHOD FOR GENERATING MESSAGE IN PORTABLE TERMINAL

(71) Applicant: Samsung Electronics Co., Ltd., Gyeonggi-do (KR)

(72) Inventor: Piotr LOWIEC, Warsaw (PL)

(73) Assignee: Samsung Electronics Co., Ltd., Gyeonggi-do (KR)

(21) Appl. No.: 14/269,597

(22) Filed: May 5, 2014

(30) Foreign Application Priority Data
May 3, 2013 (KR) 10-2013-0049923

(51) Int. Cl. G06F 3/0484; G06F 3/0486; G06F 3/0488; G06F 3/0482

(52) U.S. Cl. CPC G06F 3/04842; G06F 3/0482; G06F 3/0486; G06F 3/0488
USPC 715/769; 715/810

(57) ABSTRACT

An apparatus and a method for generating a message in a portable terminal are provided. The method includes displaying a touch area and a character area in a message display area such that the touch area and the character area intersect each other, and displaying different types of a plurality of characters on a first character area and a second character area based on an overlapping area where the touch area and the character area intersect each other.

### PRIORITY

This application claims priority under 35 U.S.C. §119(a) to a Korean Patent Application Serial No. 10-2013-0049923, which was filed in the Korean Intellectual Property Office on May 3, 2013, the entire content of which is incorporated herein by reference.

### BACKGROUND OF THE INVENTION

1. Field of the Invention

The present invention relates generally to a portable terminal, and more particularly, to an apparatus and a method for generating a message in a portable terminal.

2. Description of the Related Art

A portable terminal such as a smart phone and a tablet PC provide various useful functions for a user through various applications. Thus, there is a tendency that the portable terminal has become to an apparatus which can provide various types of information through various functions in addition to a voice communication function. In particular, such a portable terminal provides a message function of receiving a message or generating and transmitting a message.

When writing a message is requested, as illustrated in a screen of a portable terminal 101 in FIG. 1, the portable terminal provides a virtual keyboard method in which the portable terminal displays a message display area 103 and a keyboard area 105 including a virtual keyboard and then displays a character, selected by a user among a plurality of characters displayed in the keyboard area 105, in the message display area 103, so as to allow writing a message.

Alternatively, when writing a message is requested, the portable terminal provides a graffiti method in which the portable terminal displays a message display area and a graffiti area recognizing patterns and displays a character, corresponding to a pattern input through the graffiti area, on the message display area, so as to allow writing a message.

However, since such message writing methods (a virtual keyboard method and a graffiti method) display either a virtual keyboard area or a graffiti area, those methods are problematic in that they have a low screen space occupancy in proportion of a message display area (a low proportion of a message display area to the whole screen area). Further, since a plurality of key buttons displayed in the virtual keyboard area are smaller than a user's finger, there is a problem in that it is difficult to touch the key buttons by a finger and key buttons adjacent to the intended key button may be unintentionally touched together leading to display characters which a user does not want to display.

### SUMMARY OF THE INVENTION

The present invention has been made to address at least the problems and disadvantages described above and to provide at least the advantages described below.

An aspect of the present invention is to provide an apparatus for generating a message in a portable terminal, the apparatus including a display unit that displays a message display area, a touch area, and a character area; and a controller that displays the touch area and the character area in the message display area such that the touch area and the character area intersect each other, and displays different types of a plurality of characters in a first character area and a second character area based on an overlapping area where the touch area and the character area intersect each other.

Another aspect of the present invention is to provide a method of generating a message in a portable terminal, the method including displaying the touch area and the character area in the message display area such that the touch area and the character area intersect each other; and displaying different types of a plurality of characters in a first character area and a second character area based on an overlapping area where the touch area and the character area intersect each other.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a screen in which a message is generated according to the prior art;

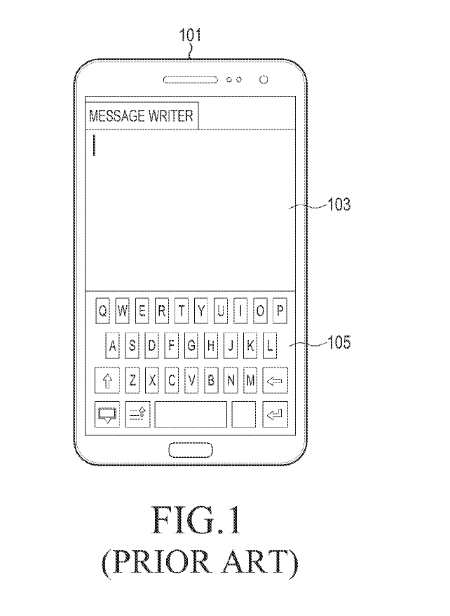

FIG. 2 illustrates screens in which a message is generated according to a first embodiment of the present invention;

FIG. 3 illustrates screens in which a message is generated according to a second embodiment of the present invention;

FIG. 4 illustrates a block diagram of a portable terminal according to an embodiment of the present invention.

FIG. 5 is a flowchart illustrating a process of generating a message in a portable terminal according to an embodiment of the present invention;

FIG. 6 is a flowchart illustrating a process of displaying a plurality of characters on a character area according to a first gesture in a portable terminal according to an embodiment of the present invention; and

FIG. 7 is a flowchart illustrating a process of displaying a character on a message display area according to a second gesture in a portable terminal according to an embodiment of the present invention.

### DETAILED DESCRIPTION OF EMBODIMENTS OF THE PRESENT INVENTION

Hereinafter, various embodiments of the present invention will be described with reference to the accompanying drawings. Further, a detailed description of known functions and configurations incorporated herein will be omitted for clarity.

According to various embodiments of the present invention, terminals include portable terminals, as well as electronic devices which cannot be easily moved. Here, the electronic devices which cannot be easily moved may be a personal computer and the like, and the portable terminals may be a video phone, a mobile phone, a smart phone, an International Mobile Telecommunication 2000 (IMT-2000) terminal, a WCDMA terminal, a Universal Mobile Telecommunication Service (UMTS) terminal, a Personal Digital Assistant (PDA), a Portable Multimedia Player (PMP), a Digital Multimedia Broadcasting (DMB) terminal, an E-Book, a portable computer (Notebook, Tablet, or the like), a digital camera, or the like.

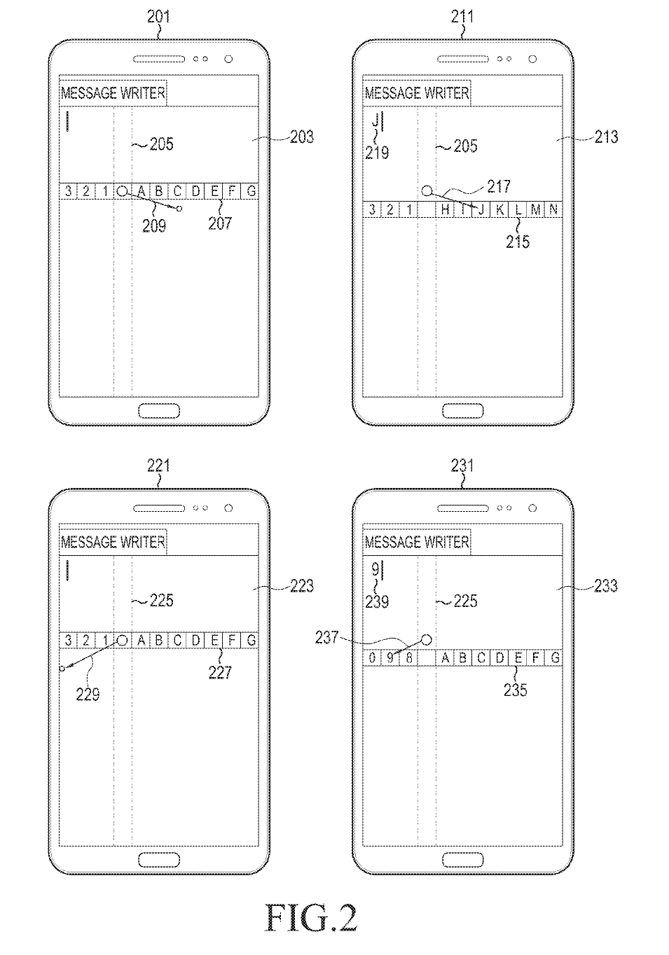

FIG. 2 illustrates screens in which a message is generated according to a first embodiment of the present invention.

Referring to FIG. 2, when writing a message is requested by a user, the portable terminal displays a touch area vertically located in a message display area and a character area horizontally located in the message display area. At this time, when execution of a specific application is requested by a user, the portable terminal determines that writing a message is requested.

Here, the message display area is an area displaying at least one character selected by a user, and the touch area is an area where a gesture for generating a message is input in order to display a message that is generated by a gesture input by a user. The character area is an area including a plurality of characters among which a user can select a desired character. The characters include numbers, letters, and special characters. The numbers may include at least one of Arabic numerals and Roman numerals. The letters refer to letters expressing various languages, and for example, may include at least one of the English alphabet, the Korean alphabet, and Chinese characters.

For example, as illustrated in a screen 201, the portable terminal may display a message display area 203, and may display a touch area 205 and a character area 207 intersecting each other in the message display area 203. At this time, the portable terminal may not display characters in an area (hereinafter, referred to as “overlapping area”) where the touch area 205 and the character area 207 intersect each other, and may display the character area 207 including Arabic numerals 1 to 3 at the left side of the overlapping area and capital letters A to G at the right side of the overlapping area.

When a first gesture is input by a user through the touch area, the portable terminal displays a plurality of new characters in the character area depending on the first gesture. Here, the first gesture is a gesture causing the plurality of characters displayed in the character area to change to a plurality of new characters. For example, the first gesture may be generated by a touch on the screen in the overlapping area, a drag toward the outside of the touch area, and a release of the touch.

For example, as illustrated in the screen 201, when a first gesture 209, generated by a touch in the overlapping area where the touch area 205 and the character area 207 intersect each other, a drag toward a right lower end, and a release of the touch, is input, the portable terminal may display a character area 215 including Arabic numerals 1 to 3 at the left side of the overlapping area and capital letters H to N at the right side of the overlapping area, as illustrated in a screen 211. As another example, as illustrated in a screen 221, when a first gesture 229, generated by a touch in the overlapping area, a drag toward a left lower end, and a release of the touch at a boundary line of the message display area 203, is input, the portable terminal may display a character area 235 including Arabic numerals 8, 9, and 0, which follow Arabic numerals 1 to 3, at the left side of the overlapping area and capital letters A to G at the right side of the overlapping area, as illustrated in a screen 231.

When a second gesture is input by a user through the touch area, the portable terminal selects one character among a plurality of characters displayed in the character area depending on the second gesture, and displays the selected character on the message display area. Here, the second gesture is a gesture causing one character to be selected among the plurality of characters displayed in the character area. For example, the second gesture may be generated by a touch in the touch area excluding the overlapping area, a drag, and a release of the touch on a specific character in the character area.

For example, as illustrated in the screen 211, when a second gesture 217, generated by a touch in the touch area 205, a drag toward a right lower end, and a release of the touch at a letter “J” displayed in the character area 215, is input, the letter “J” (219) may be displayed in the message display area 213. As another example, as illustrated in the screen 231, when a second gesture 237, generated by a touch in the touch area 225, a drag toward a left lower end, and a release of the touch at Arabic numeral “9” displayed in the character area 235, is input, the Arabic numeral “9” (239) may be displayed in the message display area 233.

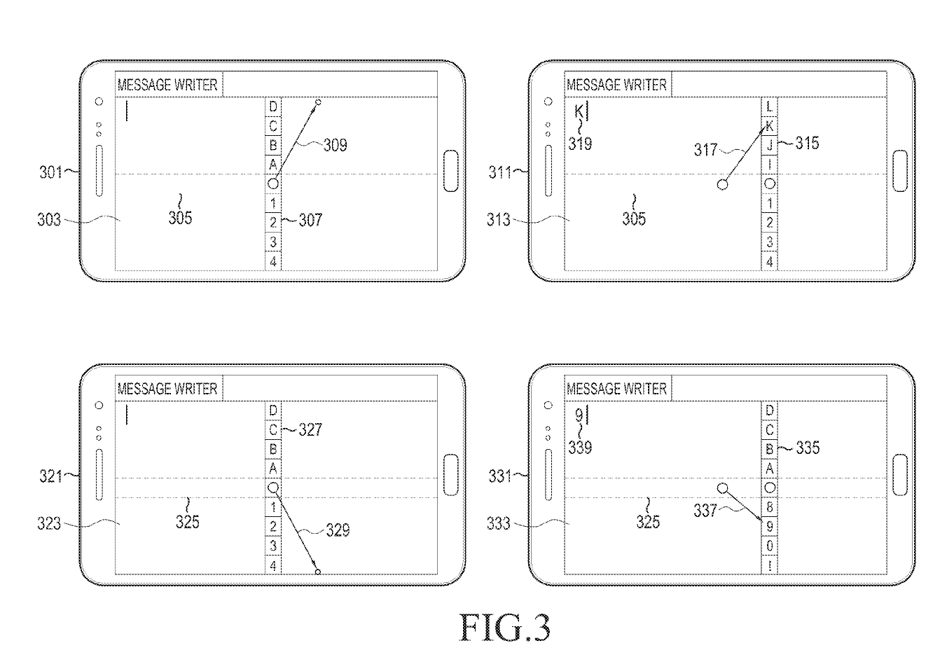

FIG. 3 illustrates screens in which a message is generated according to a second embodiment of the present invention.

Referring to FIG. 3, when writing a message is requested by a user, the portable terminal displays a touch area vertically located in a message display area and a character area horizontally located in a message display area.

For example, as illustrated in a screen 301, the portable terminal may display a message display area 303, and may display a touch area 305 and a character area 307 intersecting each other in the message display area 303. At this time, the portable terminal may not display characters in the overlapping area where the touch area 305 and the character area 307 intersect each other, and may display a character area 307 including Arabic numerals 1 to 4 at the lower side to the overlapping area and capital letters A to D at the upper side to the overlapping area.

When a third gesture is input by a user through the touch area, the portable terminal displays a plurality of new characters on the character area depending on the third gesture. Here, the third gesture is a gesture causing the plurality of characters displayed in the character area to change to a plurality of new characters. For example, the third gesture may be generated by a touch in the overlapping area, a drag toward the outside of the touch area, and a release of the touch.

For example, as illustrated in the screen 301, when a third gesture 309, generated by a touch in the overlapping area, a drag toward a right upper end, and a release of the touch at a boundary line of the message display area 303, is input, the portable terminal may display a character area 315 including Arabic numerals 1 to 4 at the lower side of the overlapping area and capital letters I to L, which follow capital letters A to D, at the upper side of the overlapping area, as illustrated in a screen 311. As another example, as illustrated in a screen 321, when a third gesture 329, generated by a touch in an overlapping area, a drag toward a right lower end, and a release of the touch at a boundary line of a message display area 323, is input, the portable terminal may display a character area 335 including Arabic numerals 8, 9, 0, and a special character “!”, which follow Arabic numerals 1 to 4, at the lower side of the overlapping area and capital characters A to D at the upper side of the overlapping area, as illustrated in a screen 331.

When a fourth gesture is input by a user through a touch area, the portable terminal selects one character among a plurality of characters displayed in a character area depending on the fourth gesture, and displays the selected character in a message display area. Here, the fourth gesture corresponds to a gesture causing one character to be selected among the plurality of characters displayed in the character area. For example, the fourth gesture may be generated by a touch in a touch area excluding an overlapping area, a drag, and a release of the touch on a specific character in the character area.

For example, as illustrated in the screen 311, when a fourth gesture 317, generated by a touch in the touch area 305, a drag toward a right upper end, and a release of the touch at a letter “K” displayed in the character area 315, is input, the portable terminal may display the letter “K” (319) in the message display area 313. As another example, as illustrated in the screen 331, when a fourth gesture 337, generated by a touch in a touch area 325, a drag toward a right lower end, and a release of the touch at Arabic numeral “9” displayed in the character area, is input, the portable terminal may display the Arabic numeral “9” (339) in a message display area 333.

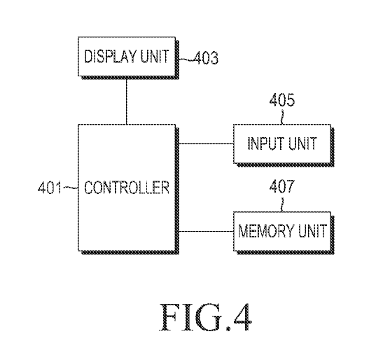

FIG. 4 illustrates a block diagram of a portable terminal according to an embodiment of the present invention.

Referring to FIG. 4, the portable terminal includes a controller 401, a display unit 403, an input unit 405, and a memory unit 407.The input unit 405 includes keys for inputting numeric information and character information and keys for setting various functions, and the display unit 403 displays video signals on a screen and data requested to be output by the controller 401. If the display unit 403 is realized by a touch display screen method such as the capacitive overlay method or the resistive overlay method, the input unit 405 may include predetermined minimal keys, and the display unit 403 may substitute a part of an input function of the input unit 405.

The memory unit 407 includes a program memory and a data memory. The program memory stores a booting and Operating System (hereinafter, referred to as “OS”) for controlling a general operation of the portable terminal, and the data memory stores various data generated during an operation of the portable terminal. In particular, the memory unit 407 stores a character group including a plurality of characters. Here, the character group includes numbers, letters, and special characters. The numbers includes at least one of an Arabic numeral group and Roman numerals, and the letters refer to characters expressing various languages, and for example, includes at least one of the English alphabet, the Korean alphabet, and Chinese characters.

The controller 401 performs a function to control an overall operation of the portable terminal. In particular, when writing a message is requested, the controller 401 displays a touch area and a character area intersecting each other in a message display area, and changes a plurality of characters displayed in the character area or selects a specific character among a plurality of characters displayed in the character area, based on a gesture input through the displayed touch area.

The controller 401 identifies whether writing a message is requested by a user. When it is identified that the writing of a message is requested by a user, the controller 401 displays the message display area, and displays the touch area and the character area in the displayed message display area. Here, the message display area is an area displaying at least one character selected by a user, and the touch area is an area where the gesture for generating a message is input in order to display a message that is generated by a gesture input by a user. Further, the character area is an area including a plurality of characters among which a user can select a desired character.

The controller 401 displays a touch area and a character area intersecting each other. For example, as illustrated in the screen 201 in FIG. 2, the controller 401 may display the touch area vertically and the character area horizontally in the message display area. As another example, as illustrated in the screen 301 in FIG. 3, the controller 401 may display the touch area horizontally and the character area vertically in the message display area.

Further, the controller 401 displays different types of a plurality of characters in a first character area and a second character area based on an overlapping area where the touch area and the character area intersect each other. For example, as illustrated in the screen 201 of FIG. 2, the controller 401 may display capital letters A to G in the first character area (e.g., the left side of the overlapping area) of the character area 207 and Arabic numerals 1 to 3 on the second character area (e.g., the right side of the overlapping area) of the character area 207 based on the overlapping area.

The controller 401 identifies whether a first gesture is input through the touch area. Here, the first gesture is a gesture causing a plurality of characters displayed in the character area to change to a plurality of new characters. For example, the first gesture may be generated by a touch in the overlapping area, a drag toward the outside of the touch area, and a release of the touch.

When it is identified that the first gesture is input, the controller 401 changes a plurality of characters displayed in the character area to a plurality of new characters.

The controller 401 identifies a movement direction of the first gesture. For example, as illustrated in the screen 201 of FIG. 2, when the first gesture 209, generated by a touch in the overlapping area where the touch area 205 and the character area 207 intersect each other, a drag toward a right lower end, and a release of the touch, is input, the controller 401 may determine that a movement direction of the first gesture 209 is a rightward direction.

The controller 401 selects a plurality of characters from a character group stored in the memory unit 407 based on the identified movement direction of the first gesture. At this time, the controller 401 selects a plurality of characters, which follow the plurality of characters displayed in the character area by the predetermined number of characters, among a number of characters included in the character group based on the movement direction of the first gesture. Here, the predetermined number refers to the number of characters which can be displayed in the character area 207.

For example, as illustrated in the screen 201 in FIG. 2, when the movement direction of the first gesture 209 is a rightward direction, the controller 401 may select letters H to N, which follow letters A to G located at the right side of the overlapping area, among a number of characters included in the character group stored in the memory unit 407.

Further, the controller 401 displays the plurality of selected characters on the character area 207. For example, when the plurality of selected characters are letters H to N, as illustrated in the screen 211 in FIG. 2, the controller 401 may display letters H to N instead of letters A to G.

When it is identified that a first gesture is not input, the controller 401 identifies whether a second gesture is input. Here, the second gesture is a gesture causing one character to be selected among the plurality of characters displayed in the character area. For example, the second gesture may be generated by a touch in the touch area excluding the overlapping area, a drag, and a release of the touch on a specific character in the character area.

When it is identified that a second gesture is input, the controller 401 displays a character selected by the second gesture in the message display area.

The controller 401 identifies a coordinate value of a position where a touch is released in the second gesture, and identifies a specific character corresponding to the identified coordinate value among the plurality of characters displayed in the character area. For example, as illustrated in the screen 211 in FIG. 2, when the second gesture 217, generated by a touch on the touch area 205, a drag toward a right lower end, and a release of the touch at a letter “J” displayed in the character area 215, is input, the controller 401 identifies a coordinate value of a position where the touch is released in the second gesture 217, and determines a specific character corresponding to the identified coordinate value among the plurality of characters displayed in the character area 215.

Then, the controller 401 displays the identified specific character in the message display area. For example, when a specific character corresponding to a coordinate value of a position where a touch is released in the second gesture 217 is a letter “J”, as illustrated in the screen 211 in FIG. 2, the controller 401 may display the letter “J” in the message display area 213.

Then, the controller 401 identifies whether terminating writing a message is requested by a user. When it is identified that the terminating writing a message is requested, the controller 401 terminates displaying the touch area and the character area. For example, as illustrated in the screen 211 in FIG. 2, after the touch area 205 and the character area 215 are displayed in the message display area 213, when terminating writing a message is requested by a user, the controller 401 may terminate displaying the touch area 205 and the character area 215, and may maintain displaying the message display area 213.

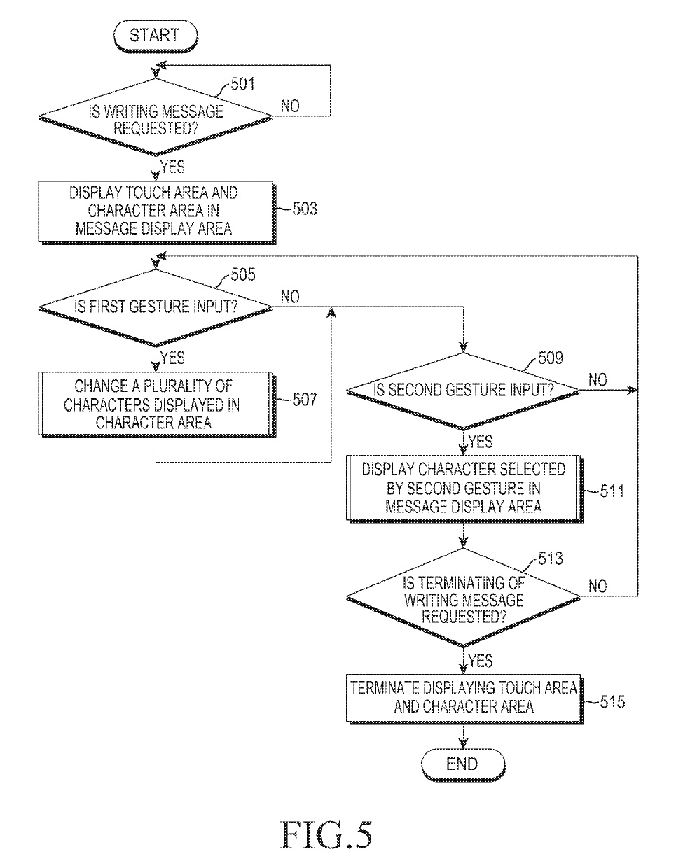

FIG. 5 is a flowchart illustrating a process of generating a message in a portable terminal according to an embodiment of the present invention.

Referring to FIG. 5, in step 501, the controller 401 identifies whether writing a message is requested by a user. If it is identified that the writing of a message is requested by a user, the controller 401 proceeds to step 503. Otherwise, the controller 401 repeatedly performs step 501.

In step 503, the controller 401 displays the message display area, displays the touch area and the character area in the displayed message display area, and then proceeds to step 505. Here, the message display area is an area displaying at least one character selected by a user, and the touch area is an area where a gesture for generating a message is input in order to display a message that is generated by a gesture input by a user. The character area is an area including a plurality of characters among which a user can select a desired character.

The controller 401 displays the touch area and the character area such that the touch area and the character area intersect each other. For example, as illustrated in the screen 201 in FIG. 2, the controller 401 may vertically display the touch area in the message display area and may horizontally display the character area in the message display area. As another example, as illustrated in the screen 301 of FIG. 3, the controller 401 may horizontally displays the touch area in the message display area and may vertically display the character area in the message display area.

The controller 401 displays different types of a plurality of characters on the first character area and the second character area based on the overlapping area where the touch area and the character area intersect each other. For example, as illustrated in the screen 201 in FIG. 2, the controller 401 may display capital letters A to G in the first character area (e.g., the left side of the overlapping area) of the character area 207 and Arabic numerals 1 to 3 on the second character area (e.g., the right side of the overlapping area) of the character area 207 based on the overlapping area.

In step 505, the controller 401 identifies whether a first gesture is input through the touch area. Here, the first gesture is a gesture causing the plurality of characters displayed in the character area to change to a plurality of new characters. For example, the first gesture may be generated by a touch in the overlapping area, a drag toward the outside of the touch area, and a release of the touch. If it is identified that the first gesture is input, the controller 401 proceeds to step 507, otherwise, the controller 401 proceeds to step 509.

In step 507, the controller 401 changes the plurality of characters displayed in the character area to a plurality of new characters, and then proceeds to step 509.

In step 509, the controller 401 identifies whether a second gesture is input. Here, the second gesture is a gesture causing one character to be selected among a plurality of characters displayed in a character area. For example, the second gesture may be generated by a touch in a touch area excluding an overlapping area, a drag, and a release of the touch on a specific character in the character area. If it is identified that the second gesture is input, the controller 401 proceeds to step 511, otherwise, the controller 401 proceeds to step 505.

In step 511, the controller 401 displays a character selected by the second gesture, and then proceeds to step 513.

In step 513, the controller 401 identifies whether terminating writing a message is requested by a user. If it is identified that terminating writing a message is requested, the controller 401 proceeds to step 515, otherwise, the controller 401 proceeds to step 505.

In step 515, the controller terminates displaying the touch area and the character area. For example, as illustrated in the screen 211 in FIG. 2, when the touch area 205 and the character area 215 are displayed in the message display area 213, and then terminating writing a message is requested by a user, the controller 401 may terminate displaying the touch area 205 and the character area 215, and may maintain displaying the message display area 213.

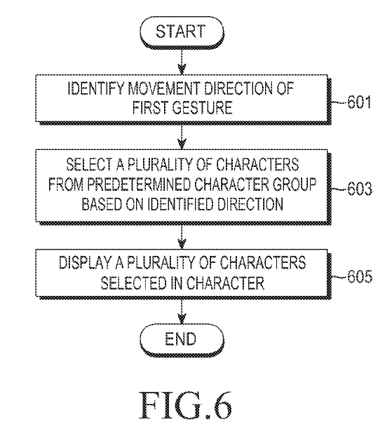

FIG. 6 illustrates the process of step 507 in detail. In step 601, the controller 401 identifies the movement direction of the first gesture, and then proceeds to step 603. For example, as illustrated in the screen 201 in FIG. 2, when the first gesture 209, generated by a touch in the overlapping area where the touch area 205 and the character area 207 intersect each other, a drag toward a right lower end, and a release of the touch, is input, the controller 401 may determine that the movement direction of the first gesture 209 is a rightward direction.

In step 603, the controller 401 selects a plurality of characters from the character group stored in the memory unit 407 based on the identified movement direction of the first gesture, and then proceeds to step 605. At this time, the controller 401 selects a plurality of characters, which follow the plurality of characters displayed in the character area by the predetermined number of characters, from a number of characters included in the character group based on the movement direction of the first gesture. Here, the predetermined number refers to the number of characters which can be displayed in the character area 207. For example, as illustrated in the screen 201 in FIG. 2, when the movement direction of the first gesture 209 is a rightward direction, the controller 401 may select letters H to N, which follow letters A to G located on the right side to the overlapping area, from a number of characters included in the character group stored in the memory unit 407.

In step 605, the controller 401 displays a plurality of characters selected in the character area 207. For example, when the plurality of selected characters are letters H to N, as illustrated in the screen 211 in FIG. 2, the controller 401 may display letters H to N instead of letters A to G.

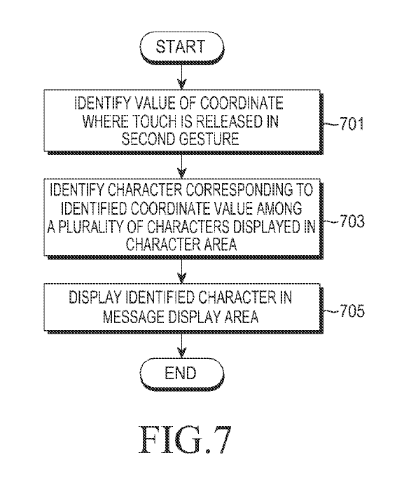

FIG. 7 illustrates the process of step 511 in detail. In step 701, the controller 401 identifies a coordinate value of a position where a touch is released in a second gesture.

In step 703, the controller 401 identifies a specific character corresponding to the identified coordinate value among a plurality of characters displayed in the character area, and then the controller 401 proceeds to step 705. For example, as illustrated in the screen 211 in FIG. 2, when the second gesture 217, generated by a touch in the touch area 205, a drag toward a right lower end, and a release of the touch on a letter “J” displayed in the character area 215, is input, the controller 401 identifies a coordinate value of a position where a touch is released in the second gesture 217, and determines a specific character corresponding to the identified coordinate value among the plurality of characters displayed in the character area 215.

In step 705, the controller 401 displays the identified specific character in the message display area. For example, when a specific character corresponding to a coordinate value of a position where a touch is released in the second gesture 217 is a letter “J”, as illustrated in the screen 211 in FIG. 2, the controller 401 may display the letter “J” in the message display area 213.

Through these operations, the present invention can increase a screen area occupancy proportion of a message display area by generating a message based on a touch area and a character area. Further, the present invention enables a user to accurately select a desired character by generating a message based on a touch area and a character area.

A method of generating a message in a portable terminal according to the various embodiments of the present invention can be realized by a code which a computer can read and stored in a record medium readable by a computer. The computer-readable recording medium includes all the types of recording devices in which data readable by a computer system are stored. Such a recording medium, for example, a ROM, a RAM, an optical disc, a magnetic tape, a floppy disc, a hard disc, or a non-volatile memory may be used, and a medium implemented in a type of carrier wave (for example, transmission through the Internet) may also be included in such a recording medium. In addition, the computer-readable recording medium with codes stored may be distributed in computer systems connected by a network such that the codes can be read and executed by a computer in a distributed method.

In the above description, although embodiments such as a mobile communication terminal has been described, various modifications may be implemented without departing from the scope of the present invention. Therefore, it is apparent that the claims of the present invention should be defined by the claims and their equivalents.

What is claimed is:

1. An apparatus for generating a message in a portable terminal, the apparatus comprising:
a display unit configured to display a message display area, a touch area, and a character area; and
a controller configured to display the touch area and the character area in the message display area such that the touch area and the character area intersect each other, and display different types of a plurality of characters in a first character area and a second character area of the character area based on an overlapping area where the touch area and the character area intersect each other.

2. The apparatus of claim 1, wherein the controller displays the touch area and the character area vertically and horizontally, respectively, or displays the touch area and the character area horizontally and vertically, respectively.

3. The apparatus of claim 1, wherein, when a first gesture is input, the controller changes a plurality of characters displayed in the character area to a plurality of new characters.

4. The apparatus of claim 3, wherein the controller identifies a movement direction of the first gesture, and changes a plurality of characters displayed in one of the first character area and the second character area to the plurality of new characters depending on the movement direction of the first gesture.

5. The apparatus of claim 3, wherein the first gesture is generated by a touch in the overlapping area where the touch area and the character area intersect each other, a drag, and a release of the touch.

6. The apparatus of claim 1, wherein, when a second gesture is input, the controller displays a specific character selected by the second gesture among the plurality of characters displayed in the character area, in the message display area.

7. The apparatus of claim 6, wherein the controller identifies a coordinate value of a position where a touch is released in the second gesture, selects a specific character corresponding to the coordinate value among the plurality of characters displayed in the character area, and displays the specific character in the message display area.

8. The apparatus of claim 6, wherein the second gesture is generated by a touch in the touch area, a drag, and a release of the touch on a specific character among the plurality of characters displayed in the character area.

9. A method of generating a message in a portable terminal, the method comprising:
displaying the touch area and the character area in the message display area such that the touch area and the character area intersect each other; and
displaying different types of a plurality of characters in a first character area and a second character area based on an overlapping area where the touch area and the character area intersect each other.

10. The method of claim 9, wherein displaying the touch area and the character area comprises displaying the touch area and the character area horizontally and vertically, respectively, or displaying the touch area and the character area vertically and horizontally, respectively.

11. The method of claim 9, further comprising, when a first gesture is input, changing the plurality of characters displayed in the character area to a plurality of new characters.

12. The method of claim 11, wherein changing the plurality of characters to a plurality of new characters comprises:
identifying a movement direction of the first gesture; and
changing a plurality of characters displayed in one of the first character area and the second character area to the plurality of new characters depending on the movement direction of the first gesture.

13. The method of claim 11, wherein the first gesture is generated by a touch in the overlapping area where the touch area and the character area intersect each other, a drag, and is a release of the touch.

14. The method of claim 9, further comprising, when a second gesture is input, displaying a specific character selected by the second gesture among the plurality of characters displayed in the character area, in the message display area.

15. The method of claim 14, wherein displaying the selected specific character comprises:
identifying a coordinate value of a position where a touch is released in the second gesture;
selecting a specific character corresponding to the coordinate value among the plurality of characters displayed in the character area; and
displaying the specific character in the message display area.

16. The method of claim 14, wherein the second gesture is generated by a touch on the touch area, a drag, and a release of the touch on a specific character among the plurality of characters displayed in the character area.
